(19) United States
(12) Patent Application Publication
(10) Pub. No.: US 2014/0089487 A1
(43) Pub. Date: Mar. 27, 2014

(54) CONTROL OF A REMOTE COMPUTER DEVICE

(71) Applicant: Jeremy Debate, Boston, MA (US)

(72) Inventor: Jeremy Debate, Boston, MA (US)

(21) Appl. No.: 14/030,160

(22) Filed: Sep. 18, 2013

Related U.S. Application Data
(60) Provisional application No. 61/706,172, filed on Sep. 27, 2012.

(51) Int. Cl. H04L 29/08

(52) U.S. Cl. CPC H04L 29/08711
USPC 709/223

(57) ABSTRACT

An agent executing on a remotely controlled mobile computer device receives control input from a remote resource over a network. The remote resource transmits the control input to the agent application to control the mobile computer device. The agent application includes an emulator function to translate the control input. The emulator is configured to produce the translated control input in a format such that it appears to an operating system of the mobile computer device that an input sensing resource local to the mobile computer device generated the control input, even though the control input is generated via hardware and/or software disposed at the remote resource over a network. The agent application in the mobile computer device utilizes the translated control input produced by the emulator to control operation of the mobile computer device.

### RELATED APPLICATIONS

This application is related to and claims the benefit of earlier filed U.S. Provisional Patent Application Ser. No. 61/706,172 entitled “CONTROL OF A REMOTE COMPUTER DEVICE,” (Attorney Docket No. APP12-04p), filed on Sep. 27, 2012, the entire teachings of which are incorporated herein by this reference.

This application is related to earlier filed U.S. Provisional Patent Application Ser. No. 61/540,218 entitled “Multi-Party Communication Sessions via Broadcast Notification Network,” (Attorney Docket No. APP11-02p), filed on Sep. 28, 2011, the entire teachings of which is incorporated herein by this reference.

This application is related to United States Patent Application entitled “CONTROL OF APPLICATIONS INSTALLED ON A REMOTE DEVICE,” (Attorney Docket No. APP12-05), filed on the same date as the present application, the entire teachings of which is incorporated herein by this reference.

### BACKGROUND

Computer software has been developed to enable a user to control a remotely located computer device. For example, remote desktop software from Microsoft™ enables a user to input commands at a local personal computer to control the remotely located computer over a network.

When using remote desktop software, the local computer operated by the user first establishes a communication link with the remote computer to be controlled. Via display information received from the remote computer, the local computer locally displays a copy of images that are currently displayed on the remote computer. Accordingly, the user at the local computer is able to view images such as windows, symbols, etc., that are currently displayed on the remote computer being controlled.

To control the remote computer, the user inputs commands at the local computer with respect to the locally displayed images (i.e., copies of images of the computer at the remote location). The user can input commands at the local computer in any suitable manner such as by the user pressing buttons on a keyboard, clicking of a computer mouse, etc.

The local computer communicates the input commands over a network connection to remote desktop software executing on the remote computer being controlled.

The remote desktop software on the remote computer receives the input transmitted over the network and communicates the input to the operating system of the remotely controlled computer. The operating system of the remote computer then determines to which of the applications the input pertains and delivers the input to the appropriate applications executing on the remote computer. Thus, according to conventional techniques, the operating system of the remote computer delivers the input directly to the applications for further execution.

The applications executing on the remote computer process the received input (i.e., clicks, drags, drops, pressed keys, etc., received from the remote computer) to identify a function in which to locally execute on the computer being remotely controlled. For example, a particular application on the remotely controlled computer receives the input and then identifies a function in the particular application to execute in accordance with the input.

### BRIEF DESCRIPTION OF DIFFERENT EMBODIMENTS AS DISCUSSED HEREIN

Conventional applications for remotely controlling a computer device suffer from deficiencies. For example, as discussed above, at the remotely located computer being controlled, the remote desktop application communicates the received input to a respective application executing on the remote computer. The respective application receiving the input then initiates execution of a respective function intended by the received input.

The conventional remote desktop software as discussed above is complex, susceptible to being slow, and typically consumes a substantial amount of power. Moreover, conventional remote desktop may only support limited remote control capabilities.

Embodiments herein deviate with respect to conventional techniques. For example, one embodiment herein includes a novel way of controlling a remotely located mobile computer device.

More specifically, in accordance with one embodiment, an agent application executing on a remotely controlled mobile computer device facilitates remote control. For example, the agent application in the mobile computer device receives control input from a remote resource over a network. The mobile computer device can include an emulator. The emulator translates the control input received from the remote resource. Subsequent to translation of the control input via the emulator, the agent application utilizes the translated control input as produced by the emulator to control operation of the mobile computer device. Thus, in accordance with one embodiment herein, on-board emulation in the mobile computer device enables remote control of the mobile computer device.

In accordance with further embodiments, the emulator (or agent application) executing on the mobile computer device emulates an input sensing resource of the mobile computer device to produce the translated control input. For example, the emulator resource in the mobile computer device produces the translated control input in a format such that it appears to the operating system of the mobile computer device that an input sensing resource local to the mobile computer device generated the control input even though the control input is actually generated by a remote controller device from hardware and/or software disposed at a remote resource.

By further way of a non-limiting example, the emulator resource executing on the mobile computer device converts the control input received from the remote resource into one or more low-level function calls representative of the control input. For example, the agent application executing on the mobile computer device utilizes the translated control input such as low-level operating system function calls produced by the emulator to control operation of the mobile computer device. As an example, the agent application can initiate execution of the one or more function calls by the operating system of the mobile computer device (or a kernel of the operating system) to control operation of the mobile computer device.

Note that execution of an emulator resource in the mobile computer device is shown by way of non-limiting example only and that emulation as discussed herein can be performed in any suitable resource such as in the mobile computer device, remote resource, etc.

These and other embodiments are discussed in more detail below.

As mentioned above, note that embodiments herein can include a configuration of one or more computerized devices, workstations, handheld or laptop computers, personal computers, or the like to carry out and/or support any or all of the method operations disclosed herein. In other words, one or more computerized devices or processors in a resource such as a mobile computer device can be programmed and/or configured to operate as explained herein to carry out different embodiments of the invention. Additionally, in one example embodiment, more than one remote administrator may simultaneously control one or more computerized devices.

Yet other embodiments herein include software programs to perform the steps and operations as discussed herein. One such embodiment comprises a computer program product including a non-transitory computer-readable storage medium (i.e., any suitable computer readable hardware storage medium) on which software instructions are encoded for subsequent execution. The instructions, when executed in a computerized device having a processor, program and/or cause the processor to perform the operations disclosed herein. Such arrangements are typically provided as software, code, instructions, and/or other data (e.g., data structures) arranged or encoded on a non-transitory computer readable storage medium (i.e., any computer readable hardware storage media) such as an optical medium (e.g., CD-ROM), floppy disk, hard disk, memory stick, etc., or other medium such as firmware or microcode in one or more ROM, RAM, PROM, etc., or as an Application Specific Integrated Circuit (ASIC), etc. The software or firmware or other such configurations can be installed on a computerized device to cause the computerized device to perform the techniques explained herein.

Accordingly, one particular embodiment of the present disclosure is directed to a method and computer program product that includes a computer readable hardware storage medium having instructions stored thereon. For example, in one embodiment, the instructions, when executed by one or more processor devices in a computer system such as a mobile computer device, cause the one or more processor devices to: receive control input from a remote resource over a network, the control input generated to control the mobile computer device from a remote location; via an emulator resource, translate the control input received from the remote resource; and utilize the translated control input (such as one or more operating system function calls) produced by the emulator to control operation of the mobile computer device.

The ordering of the steps has been added for clarity sake. These steps can be performed in any suitable order.

Other embodiments of the present disclosure include software programs and/or respective hardware to perform any of the method embodiment steps and operations summarized above and disclosed in detail below.

It is to be understood that each of the multitude of systems, methods, apparatuses, instructions on computer readable storage media, etc., as discussed herein can be embodied strictly as a software program, as a hybrid of software and hardware, or as hardware alone such as within a processor, or within an operating system or a within a software application.

Additionally, although each of the different features, techniques, configurations, etc., herein may be discussed in different places of this disclosure, it is intended that each of the concepts can be executed independently of each other or, where suitable, the concepts can be used in combination with each other. Accordingly, the one or more present inventions as described herein can be embodied and viewed in many different ways.

Also, note that this preliminary discussion of embodiments herein does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), and additional points of novelty, the reader is directed to the Detailed Description section and corresponding figures of the present disclosure as further discussed below.

### BRIEF DESCRIPTION OF THE DRAWINGS

FIG. 1 is an example diagram illustrating remote management of a mobile computer device over a network according to embodiments herein.

FIG. 2 is an example diagram illustrating generation and transmission of display information according to embodiments herein.

FIG. 3 is an example diagram illustrating an emulator resource providing input translation according to embodiments herein.

FIG. 4 is an example diagram illustrating persistence of an agent and/or corresponding communication link according to embodiments herein.

FIG. 5 is an example diagram illustrating registration information used by respective servers in a notification network to facilitate distribution of messages according to embodiments herein.

FIG. 6 is an example diagram illustrating use of a notification network to enable a remote resource to communicate with a mobile computer device and control operation of a mobile computer device according to embodiments herein.

FIG. 7 is an example diagram illustrating registration information used by respective servers in a notification network to facilitate distribution of messages according to embodiments herein.

FIG. 8 is an example diagram illustrating an example computer architecture for implementing functionality according to embodiments herein.

FIG. 9 is a flowchart illustrating an example method facilitating remote control of a mobile computer device according to embodiments herein.

FIG. 10 is a flowchart illustrating an example method facilitating control of a mobile computer device according to embodiments herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DETAILED DESCRIPTION

According to embodiments herein, an agent executing on a remotely controlled mobile computer device receives control input from a remote resource over a network. The remote resource transmits the control input to the agent to control the mobile computer device. The agent in the mobile computer device relies on emulation to translate the control input. For example, an emulator resource in the mobile computer device or other resource is configured to produce the translated control input in a format such that it appears to an operating system of the mobile computer device that an input sensing resource local to the mobile computer device generated the control input, even though the control input is actually generated via hardware and/or software disposed at the remote resource. Thus, in some respects, the operating system in the mobile computer device views the agent application and/or emulator resource as a local piece of external hardware that locally receives the control input from a local user.

By way of further non-limiting example, the agent in the mobile computer device utilizes the translated control input (such as one or more operating system function calls) produced by the emulator to control operation of the mobile computer device. Thus, via emulation, an emulator resource can be configured to replicate input commands such as hardware events in a target computing being remotely controlled.

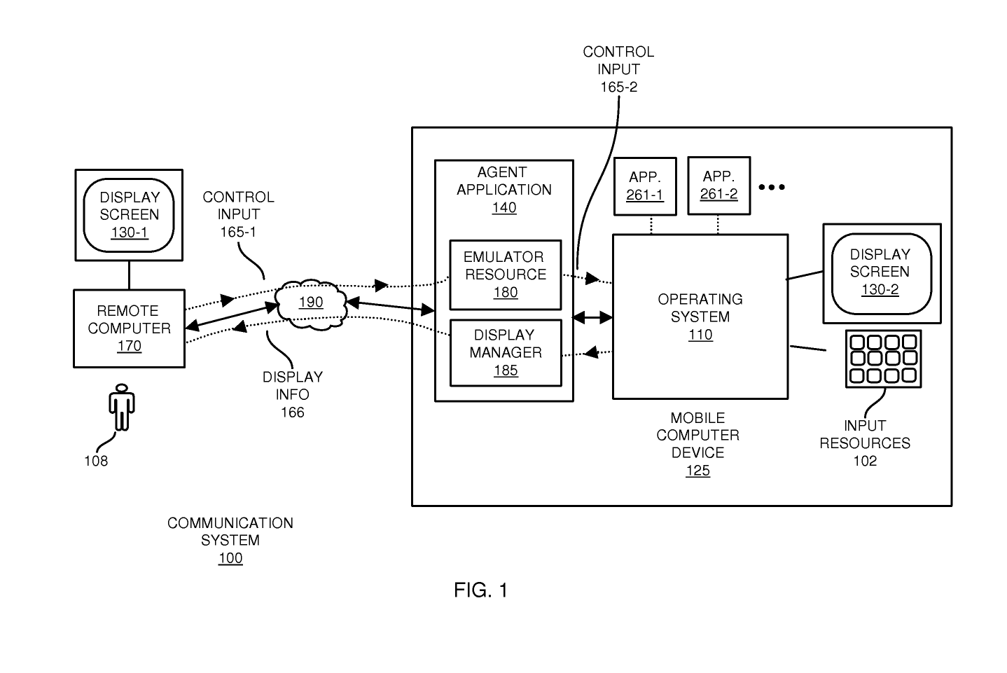

More specifically, FIG. 1 is an example diagram illustrating remote management of a mobile computer device according to embodiments herein.

As shown, communication system 100 includes a remote computer 170 (i.e., a remote resource) and respective display screen 130-1. Remote computer 170 can be any type of computer device enabling a user to provide input commands to control the mobile computer device 125.

Mobile computer device 125 in this example embodiment can be any suitable type of computer processing device such as an iPhone™, iPad™, Blackberry™, Android™, Smartphone™, personal computer, etc.

Mobile computer device 125 can include any of one or more input resources 102. Input resources 102 enable local control of the mobile computer device 125. For example, the mobile computer device 125 can include a keyboard, touch-screen, physical buttons such as ON/OFF buttons, volume buttons, etc., on which to receive input commands to locally control aspects of the mobile computer device 125 as well as corresponding applications 261 (e.g., application 261-1, 261-2, etc.).

As is known in conventional applications, the display screen 130-2 local to mobile computer device 125 provides a medium on which the operating system 110 and one or more executable applications 261 initiate display of information to a respective operator of the mobile computer device 125.

In certain instances, the user 108 may desire to remotely control the mobile computer device 125. That is, the user 108 may not be physically located in a same vicinity of the mobile computer device 125 to control it.

To remotely control the mobile computer device 125 over network 190, a user 108 operates the remote computer 170 (e.g., a remote resource) to produce input commands (e.g., control input 165-1). For example, in one embodiment, display screen 130-1 displays a graphical user interface enabling the user to provide input commands and control the mobile computer device 125. In other words, the graphical user interface disposed on display screen 130-1 may be a browser enabling the respective user 108 to view a copy of images currently displayed on display screen 130-2.

Remote computer 170 transmits received commands from user 108 as input 165-1 over the network 190 to agent application 140. In one embodiment, the control input captures the raw input received by the remote computer 170 from the user 108.

As further discussed herein, agent application 140 receives the control input 165-1 generated by the user 108. In one example embodiment, as will be discussed in more detail later in this specification, the emulator resource 180 of the agent application 140 converts the control input 165-1 into one or more low-level function calls to operating system 110 to execute respective commands inputted by the user 108.

In one example embodiment as briefly mentioned, to facilitate control of the mobile computer device 125 by user 108 at a remote location, the agent application 140 initiates transmission of display information 166 over network 190 to remote computer 170.

The display information 166 can include a copy of images that are displayed (or images that would be displayed or played back) on the display screen 130-2 if the user 108 were locally controlling the mobile computer device 125. Accordingly, a user 108 can view a state of the mobile computer device 125.

Remote computer 170 receives the display information 166 over network 190 or other suitable resource. The remote computer 170 utilizes the received display information 166 to locally display a copy of images also displayed on display screen 130-1. Accordingly, the user 108 at a remote location with respect to the mobile computer device 125 is able to view images displayed (or would be displayed) on display screen 130-2 even though the user 108 is remotely located with respect to the mobile computer device 125. The images received by user 108 may also be recorded as a series of still frames or encoded into a suitable video format for later replay.

As will be discussed later in this specification, note that the graphical user interface on display screen 130-1 also can display selectable functionality associated with mobile computer device 125 that is not necessarily displayed on the display screen 130-2. For example, the mobile computer device 125 can include one or more physical switches, control buttons, etc., with which to control different functions of the mobile computer device 125. The graphical user interface displayed on display screen 130-1 can enable a respective user 108 to provide input to control the one or more physical switches, control buttons, etc., of the mobile computer device 125. Via appropriate input to the remote computer 170, the user 108 is able to control such functions as well.

As an example, suppose that the mobile computer device 125 is powered OFF and there is a physical button on the mobile computer device 125 that needs to be pressed to turn the mobile computer device 125 to an ON state. In such an instance, the graphical user interface displayed on the display screen 130-1 can include display of a selectable symbol so that the user 108 at the remote computer 170 can select the symbol and turn ON the mobile computer device. In such an instance, the agent application 140 can emulate physical buttons of the target mobile computer device 125 based on input from the remotely located user 108 providing input to the graphical user interface displayed on display screen 130-1.

The graphical user interface such as a browser displayed on the display screen 130-1 can be a simple interface. Some other resource such as a server in network 190 providing access to the mobile computer device 125, or the agent application 140, etc., can create the graphical user interface on the display screen 130-1 to include a selectable symbol for display on the browser of the remote computer 170 such that the user 108 could provide input with respect to the symbol (e.g., virtual power button on display screen 130-1) and remotely control the functionality of the physical button of the mobile computer device 125.

Accordingly, via the kernel-level communication protocol as discussed herein, the agent application 140 and respective resources are able to emulate the press of any the physical buttons (home button, power button, volume buttons, etc.) on the mobile computer device 125 device.

In one embodiment, the display screen 130-1 displays a remote control interface including two symbols (e.g., software buttons) labeled ‘home’ and ‘lock’. Selecting either of these symbols on display screen 130-1 results in transmission of a respective message (e.g., control input 165-1) to the agent application 140. For example, selection of the home button at the remote computer 170 causes the remote computer 170 to send a message to the agent application 140. The agent application 140 in turn emulates the pressing of the home button of the mobile computer device 125 by generating the appropriate function calls to the operating system 110. Accordingly, via the agent application 140, it appears to the mobile computer device 125 that the user pressed a local home button of the mobile computer device 125.

In accordance with further embodiments, the agent application 140 translates the messages into a kernel payload for that specific event. For example, when the mobile computer device 125 is off, the user 108 can remotely issue a command to turn it ON via selection of the ON button. The user 108 at remote computer 170 can also perform a ‘slide to unlock’ command to access the mobile computer device 125.

Thus, based on input from user 108 or other resource providing input to control the mobile computer device 125, the remote computer 170 forwards the information as control input 165-1 over network 190 to the agent application 140. As an example, depending on the type associated with remote computer 170, such as whether the remote computer is a personal computer or Apple™ based computer, the remote computer 170 can receive different types of input such as clicks, swipes, pressed buttons, kepypad input, mouse movements, touchscreen input, pinch/zoom commands, etc., applied to images displayed on display screen 130-1. The remote computer 170 forwards the received input over network 190 to agent application 140 executing on mobile computer device 125.

As mentioned, the agent application 140 includes or has access to use of emulator resource 180 to convert the control input 165-1 into a format suitable for mobile computer device 125. For example, in one embodiment, the remote computer 170 produces and transmits the control input 165-1 in a first format over network 190 to agent application 140. As previously discussed, the control input 165-1, which may be encoded in accordance with a first format, captures raw input such as pressing of buttons, clicking of a mouse, dragging of a mouse, etc., inputted by the user 108 operating remote computer 170.

Also as mentioned, the first format may not be suitable for directly controlling the mobile computer device 125. In other words, the mobile computer device 125 and/or operating system 110 may not be configured to decode and/or execute the commands in the first format as captured by the control input 165-1.

As a solution, the agent application 140 can include and/or have access to use of an emulator resource 180.

By further way of non-limiting example, the agent application 140 initiates translation of the control input 165 received from the remote computer 170 via use of the emulator resource 180. That is, in one embodiment, the emulator resource 180 converts or translates the control input 165-1 into control input 165-2. Translation can include converting the control input 165-1 in the first format into control input 165-2 in a second format that is executable by the mobile computer device 125.

That is, in accordance with one embodiment, the emulator resource 180 translates the control input 165-1 received from the remote computer 170 into translated control input 165-2 (e.g., in a second format). The agent application 140 can be configured to utilize the translated control input 165-2 produced by the emulator resource 170 to control operation of the mobile computer device 125.

Translation of the control input 165-1 into translated control input 165-2 can include emulating an input sensing resource that is compatible with the mobile computer device 125. In other words, in one embodiment, the emulator resource 180 converts the control input 165-1 into translated control input 165-2 to emulate hardware and/or software resources that is compatible with the mobile computer device 125.

Thus, the emulator resource 180 as discussed herein can be configured to emulate an input sensing resource local to the mobile computer device 125 to produce the translated control input 165-2. The emulator resource 170 produces the translated control input 165-2 in a format as if a compatible, local input sensing resource of the mobile computer device 125 generated the input as opposed to being generated by the remote computer 170; even though the control input 165-1 originates from the remote computer 170.

In accordance with further embodiments herein, note that the remote computer 170 need not generate the control input 165-1 in any special format as the emulator resource 170 can be configured to perform appropriate conversion of raw input from one form to another that is suitable for execution at the mobile computer device 125.

Note further that, because the emulator resource 170 performs emulation as discussed herein, the remote computer 170 need not include any sophisticated software and/or hardware to produce the control input 165-1. In other words, the user 108 at the remote computer 170 can execute relatively simple hardware and/or software such as a simple browser application to view display information 166 (e.g., copies of information played back on the mobile computer device 125) and subsequently generate the control input 165-1 with respect to the respective display information displayed on display screen 130-1. As previously discussed, the images displayed on the browser graphical user interface displayed on the display screen 130-1 can be received from any suitable resource. According to one embodiment, the translated control input and display information may be serialized in a manner independent from the specifics of either computer device.

By further way of a non-limiting example, note that the translated control input 165-2 produced by the emulator resource 180 can specify one or more functions calls that are to be made to the operating system 110 to carry out functionality intended by the control input 165-1. In other words, in accordance with one embodiment, the emulator resource 180 can be configured to translate control input 165-1 such as swipes, clicks, drags and drops, pinch/zooms, etc., into low-level operating system function calls. In one embodiment, these low-level operating system function calls will, under normal operation, be forwarded to other applications running on the device. This allows a uniform control protocol control over any applications that would normally be locally usable on that device.

As mentioned, the type of control input inputted to control the mobile computer device 125 can vary depending on the type of remote computer 170 (e.g., personal computer, Apple computer, etc.) that is used by the user 108 to generate the control input 165-1.

In accordance with further embodiments, the agent application 140 uses the translated control input 165-2 such as one or more low-level function calls produced by the emulator resource 170 to control operations of the mobile computer device 125.

More specifically, in one embodiment, the agent application 140 can be configured to communicate the one or more function calls to the operating system 110 of the mobile computer device to control operation of the mobile computer device 125 in accordance with the control input 165-1.

In a further example embodiment, the agent application 140 can be configured to execute the one or more function calls directly by a kernel of the operating system 110.

The agent application 140 can be retrieved and installed on the mobile computer device 125 in accordance with any suitable manner. For example, in accordance with one embodiment, a user operating the mobile computer device 125 can initiate retrieval of an installation package over a network. The user can execute an installer application to install the agent application 140 on the mobile computer device 125.

To ensure that the agent application 140 persistently executes on the mobile computer device 125, the agent application 140 can be registered as an application to be executed and/or or launched each time the mobile computer device 125 is rebooted. Thus, embodiments herein can include initiating execution of the agent application 140 on the mobile computer device 125 during reboot of the mobile computer device 125.

Any suitable method can be used to ensure that the agent application 140 persistently executes on the mobile computer device 125 in all of multiple possible modes.

As discussed herein, the agent application 140 can be persistently executing even though the mobile computer device is shut off, powered down, in a sleep mode, standby mode, low-power mode, etc. In one embodiment, the agent application 140 is persistently executed as a background process on the mobile computer device 125. In these instances, because the agent application 140 is persistent, the user 108 can initiate remote control of the mobile computer device at substantially any time via communication with the agent application 140. In other words, the persistent communication link makes it possible to remotely control the mobile computer device 125 at any time from a remote computer.

Also, note that the emulator resource 180 is shown as being located in the agent application 140 of the mobile computer device 140. However, note that the emulator resource 180 can reside in any computer device, remote or local with respect to the mobile computer device 125. In other words, the emulator resource 180 does not necessarily need not to be located in the mobile computer device 125. It can reside at a location such as at the remote computer 170.

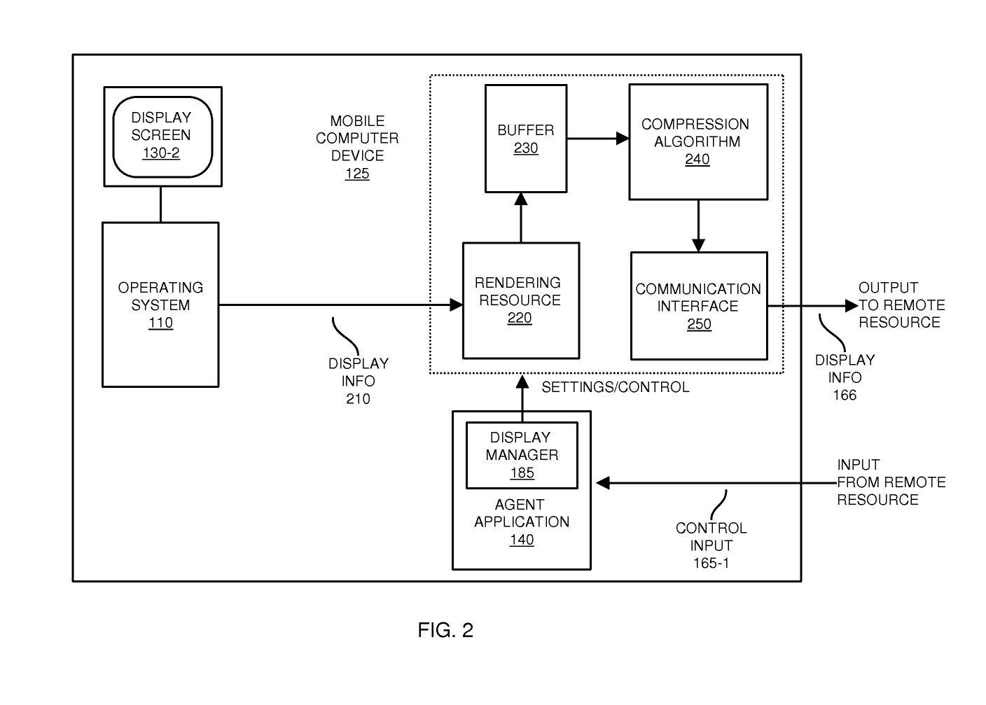

FIG. 2 is an example diagram illustrating generation and transmission of display information according to embodiments herein.

As previously discussed, the operating system 110 can include appropriate hardware and software resources to drive local display screen 130-2.

One embodiment herein may include spoofing the operating system 110 of the mobile computer device 125 that the operating system 110 is driving a locally disposed auxiliary display device as an alternative to or in addition to driving the main display screen 130-2 of the mobile computer device 125. For example, the agent application 140 can be configured to set configuration settings of the mobile computer device 125 such that the mobile computer device 125 believes that it is driving a local auxiliary display device even though it is not locally driving such a device.

In such an embodiment, the operating system 110 or other appropriate processor resources (e.g., display software, etc.) associated with the mobile computer device 125 produces display information 210. By way of a non-limiting example, the display information 210 captures a copy of images intended for local display on display screen 130-2 (if it happens to be in an ON state).

Note that, to save power, the display screen 130-2 may be unpowered or turned to an OFF state when the user 108 controls the mobile computer device 125 from remote computer 170.

On the other hand, there may be instances during which a user would like the display screen 130-2 to be turned to an ON state such as when the user 108 at remote computer 170 is remotely performing a tutorial for a user currently viewing the display screen 130-2 on the mobile computer device 125.

In accordance with further example embodiments, the agent application 140 can be configured to generate one or more commands (potentially based on input over network 190 from the user 108 at remote computer 170) to control whether the display screen 130-2 is to be powered ON or OFF.

In furtherance of generation and transmission of display information 166 to the remote computer 170, via display manager 185, the agent application 140 can be configured to initiate execution of rendering resource 220 to produce a copy of images in a selected format. The format can be select by the display manager 185 of agent application 140. For example, the settings information received from the display manager 185 can indicate details such as a format in which to convert and/or store display information 210 for subsequent display on a graphical user interface displayed on display screen 130-1. In accordance with such settings, the rendering resource 220 produces and stores the formatted display information 210 in buffer 230.

Buffer 230 can include a matrix or uncompressed bit map of information to store pixel setting information representing a copy of images intended for display on a display screen 130-2. Based on target display screen 130-1 and its ability to display information, the display manager 185 can specify which of one or more possible formats and/or settings of the image information that is to be stored in buffer 230.

In one embodiment, the buffer 230 can be a hardware-accelerated pixel buffer.

As briefly mentioned, the display manager 185 of agent application 140 can specify low-level details about the target screen (e.g., display screen 130-1) to which the display information in buffer 230 will eventually displayed. Generating and storing the display information in buffer in accordance with hardware and/or software of the remote computer 170 that eventually displays the display information may alleviate or reduce an amount of processing needed by the receiving device (e.g., remote computer 170) to display appropriate image information since the display information would already be in an appropriate format. Thus, as mentioned above, a graphical user interface or a browser executed on the display screen 130-1 of remote computer 170 need not be particularly sophisticated.

In one non-limiting example embodiment, note that to save on network bandwidth and use of processing resources, mobile computer device 125 can determine whether the current display information is identical to the most recently sent information. In this instance, the duplicate display information will not be captured, processed or transmitted over the network. To provide additional optimizations, computer device 125 may further include compression algorithm 240.

As its name suggests, compression algorithm 240 compresses the display information stored in buffer 230 prior to transmission over network 190.

Communication interface 250 transmits the compressed display information over network 190 to the remote computer 170 for display on display screen 130-1.

In one embodiment, the communication interface 250 transmits a compressed (or potentially uncompressed as the case may be) version of the display information stored in buffer 230 in response to a command by the remote computer 170 to do so.

For example, the agent application 140 can receive control input 165-1 indicating to transmit the display information in buffer 230 to the remote computer 170. In response to receiving the command, the display manager 185 of the agent application 140 initiates transmission of the display information in buffer over the network 190. Each time the remote computer 170 sends a command to the agent application 140 to transmit updated display information from buffer 230, the agent application 140 initiates transmission of a current version of images (i.e., display information) stored in buffer 230 to the remote computer 170 for display on display screen 130-1.

Transmitting the display information only in response to a command from the remote computer 170 can save on battery power in the mobile computer device 125. For example, repeatedly capturing a copy of images and/or transmitting the display information over network 190 when it is not necessary can waste a substantial amount of power. As an example, the remote computer 170 may not need a repeated refresh of the images on display screen 130-2, for example, every 1/30^{th} of a second. Instead, the remote computer 170 may require updates at a much slower rate as specified by the remote computer 170.

In accordance with alternative embodiments, the agent application 140 can configure the mobile computer device 125 to produce and transmit the updated display information based on a specified refresh rate.

Thus, in accordance with one embodiment, the agent application 140 can be configured to set one or more parameters to control local generation of display information (e.g., playback information) in the mobile computer device 125. The parameters can be set at least in part in accordance with a display screen 130-1 at the remote computer 170 controlling the mobile computer device 125. In accordance with the parameters, the mobile computer device 125 stores the playback information in a buffer of the mobile computer device 125. The display information in buffer 230 can include a copy of images produced for display on a main display screen 130-2 of the mobile computer device 125. The agent application 140 initiates transmission of the display information in the buffer 230 over network 190 to the remote computer 170.

In accordance with further embodiments, note again that the agent application 140 can be a background process such as a daemon running on the mobile computer device 125 unbeknownst to the operator of the mobile computer device 125. For example, the agent application 140 may be configured in a way that the agent application 140 does not appear as an available application in a home screen or desktop for execution. The fact that the agent process 140 is currently executing on the mobile computer device 125 may not be visible to the operator of the mobile computer device 125. In such an instance, an operator of the mobile computer device 125 may not be able to disable the agent application 140.

In accordance with alternative embodiments, the user 108 of mobile computer device 125 may be notified that the agent application 140 is being executed. If desired, the user 108 may terminate execution of the agent application 140 to prevent remote control of the mobile computer device 125.

Additionally, the agent application 140 can be registered as an available application manually executed by the operator of the mobile computer device 125 to enable the remote control capabilities as discussed herein.

Note that bi-directional communications between the remote computer 170 and the mobile computer device 125 are not limited to control input 165-1 and display information 166. Instead, communications can include any appropriate messaging that facilitates remote control of the mobile computer device 125, or augments the use case for remote control of the mobile computer device.

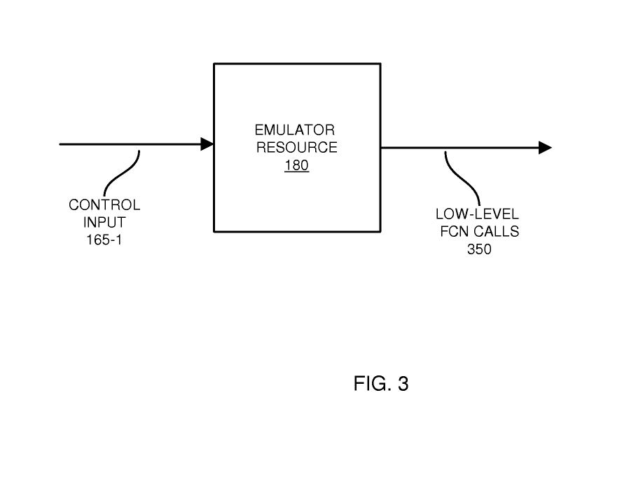

FIG. 3 is an example diagram illustrating translation of input control information according to embodiments herein.

As previously discussed, the emulator resource 180 of agent application 140 receives control input 165-1 over network 190 from a remotely controlling resource such as remote computer 170.

Assume in this example that the remote computer 170 is a personal computer operated by user 108 and that the control input 165-1 specifies a mouse click down by user 108 at location X1, Y1 on display screen 130-1 and a subsequent mouse click up at X2, Y2 on display screen 130-1 with respect to a rendition of display information 166 displayed on display screen 130-1. In one embodiment, this input corresponds to a swipe gesture to be performed on a target device (e.g., mobile computer device 125) such as an iPhone™, IPAD™, etc.

In accordance with further embodiments, the emulator resource 180 can be configured to convert the control input 165-1 (e.g., down click, sliding of the mouse pointer, and upclick of the mouse, etc.) into an appropriate swipe gesture as if the corresponding input were generated locally by an input resource of the mobile computer device 125. In this instance, the emulator resource 180 converts the mouse control inputs into one or more low-level function calls 350 to be executed by the operating system 110 to carry out the swipe gesture.

Note that the emulator resource 180 can take into account resolution variations, different sized display screens, etc., with respect to the images on display screen 130-1 and the images on display screen 130-2.

As an example, a portion of the control input 165-1 can specify a location of the corresponding control events (e.g., down click, pointer movement, up click, etc.) with respect to the images (e.g., symbols, text, etc.) displayed on display screen 130-1 to which the user 108 applies the commands. The corresponding images on the display screen 130-2 may be displayed in accordance with a different coordinate system. The emulator resource 180 and/or other suitable resource can be configured to take into account the different coordinate systems by mapping inputted control events with respect to images on the display screen 130-1 to corresponding control events with respect to images on display screen 130-2. Thus, assuming an input is a selection of a given symbol, input applied to the given symbol on display screen 130-1 is translated into an appropriate input to a corresponding symbol on display screen 130-2.

As a further example, any device-level interactions such as keyboard and touch screen events (as received from the remote computer 170) to be executed on the mobile computer device 125 can be performed via direct communications by the agent application 140 to the kernel of the operating system 110. This can include creating a specially formatted payload for each action. More specifically, assume that a user taps on coordinates (100,200) of the display screen 130-1. The emulator resource 180 converts these coordinates to corresponding coordinates on the mobile computer device 125. The coordinates may vary from device to device, as each device may have a slightly different geometry. Embodiments herein can include accounting for rotation, changes in resolution, etc., and then bundle information associated with the command to be executed into a special data structure which the kernel or operating system 110 recognizes.

For a swipe gesture, the agent application 140 receives the ‘start’ and ‘end’ coordinates, and then calculates a number of intermediate locations that lie on the line between start and end. In accordance with further embodiments, the agent application 140 issues a timed series of kernel events, effectively ‘moving’ the mouse to each intermediate point on the line. Accordingly, the agent application 140 can emulate a swipe event, based on receipt of only a selected start (e.g., a down click of a mouse button at the remote computer 170) and selected end point (e.g., up click of the mouse button at the remote computer 170).

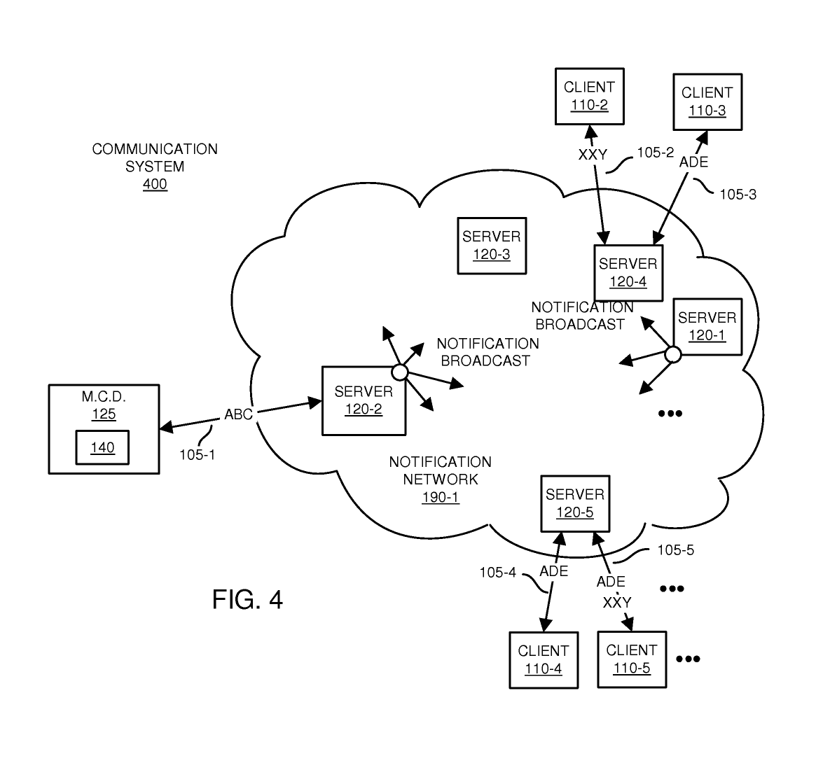

FIG. 4 is an example diagram illustrating a notification network facilitating distribution of messages amongst resources according to embodiments herein.

As shown, communication system 400 includes notification network 190-1 providing connectivity between communication resources. In this example, the mobile computer device 125 is a client connected to a server 120-2 in network 190-1. Network 190-1 can be any suitable network such as a packet-switched network supporting conveyance of messages from one resource to another.

Communication link 105-1 such as a wireless link connects the mobile computer device 125-1 to network 190-1. By way of a non-limiting example, the communication link 105-1 between the mobile computer device 125 and the server 120-2 can be a persistent link (e.g., persistent network connection) even though no communications are transmitted over the communication link 105-1. That is, the mobile computer device 125 and the server 120-2 maintain the communication link 105-1 even though there may be no traffic transmitted over the communication link 105-1.

In this example, communication link 105-1 has been configured to support communications for communication session ABC. In other words, any other resource in communication system 400 that is part of communication session ABC is able to communicate with the mobile computer device 125 over the communication link 105-1.

Further in this example embodiment, no other computer resources are currently members of communication session ABC. In other words, assume in this example that the remote computer 170 has not yet joined communication session ABC to send messages (e.g., control input 165-1) to control the mobile computer device 125. In such an instance, no other communications are received by the agent application 140 in the mobile computer device 125 other than possible heartbeat signaling that takes place between the mobile computer device 125 and the server 120-2. More specifically, if desired, the agent application 140 can communicate a keep-alive message in a reverse direction back to server 120-2 to notify the server 120-2 that the communication link 105-1 is still functional.

As previously discussed, the agent application 140 as well as any socket in the mobile computer device 125 on which to receive communications directed to the agent application 140 can be persistent. For example, the socket opened by the operating system 110 on behalf of the agent application 140 on which to receive communications over communication link 105-1 can be active even though the mobile computer device happens to be depowered (i.e., turned OFF), in a sleep mode, low-power mode, standby mode, etc. Thus, the agent application 140 can receive messages (if they happen to be sent) at any time, even when the mobile computer device is turned OFF.

Note that the communication link 105-1 can be persistent, akin to a VOIP (Voice Over Internet Protocol) or other suitable type of connection enabling the agent application 140 in the mobile device to receive and transmit messages as long the mobile computer device 125 is powered by a battery.

Establishing the communication link 105-1 can include opening an appropriate HTTP type communication socket in the mobile computer device 125 enabling the agent application 140 to communicate with server 120-2 and other remote resources. In one non-limiting example embodiment, the communication link is established via the WebSocket extension of the HTTP protocol (e.g., via a request header upgrade:websocket), although any suitable bi-directional socket can be used.

Communications between endpoints can be Transmission Control Protocol/Internet Protocol data.

As previously discussed, the servers 120 and communication links 105 in notification network 190-1 facilitate communication between resources via broadcast messages. For example, a resource such as client 110-2 can be a member of communication session XXY. Respective communication link 105-2 has been established for such communications.

In one embodiment, in response to receiving a message on communication link 105-2 (for communication session XXY) from client 110-2, the server 120-4 sends a broadcast of the received message to other servers in notification network 190-1. The broadcasted message indicates that the message belongs to communication session XXY.

Each of the other servers 120 receiving the broadcast message forwards the message to any clients that are members of the communication session XXY. In this case, server 120-5 receives the broadcasted message associated with communication session XXY and detects that communication link 105-5 to client 110-5 supports communications associated with communication session XXY. The server 120-5 then forwards the message generated by client 110-2 to client 110-5.

Other servers such as server 120-2 receiving the messages for communication session XXY does not forward the message to respective clients 110-3, 110-4, etc., because the message is not directed to such destinations.

Additional details of notification network 190-1 and corresponding functionality can be found in earlier filed U.S. Provisional Patent Application Ser. No. 61/540,218 entitled “Multi-Party Communication Sessions via Broadcast Notification Network,” (Attorney Docket No. APP11-02p), filed on Sep. 28, 2011, the entire teachings of which are incorporated herein by this reference.

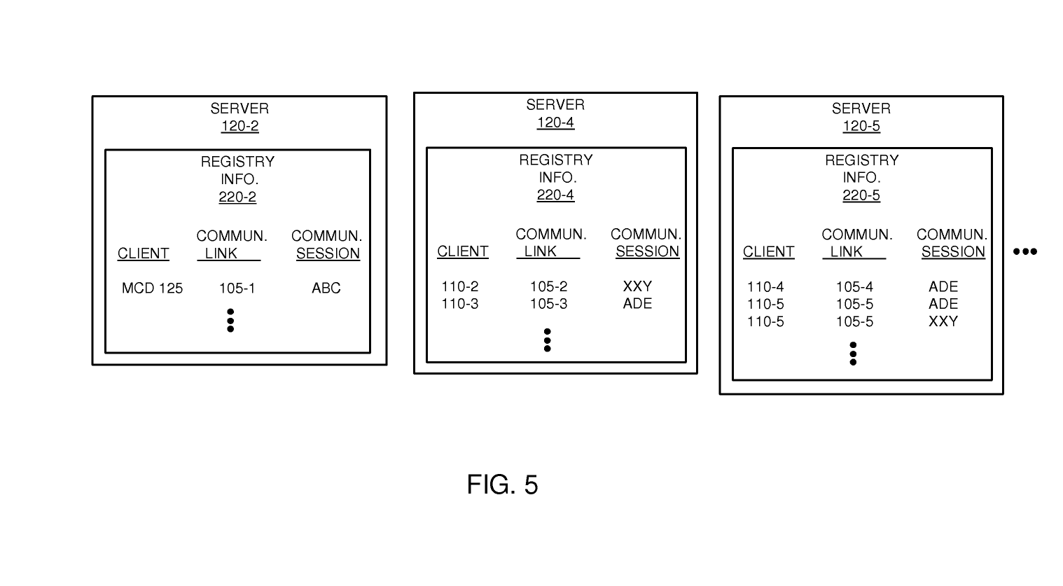

FIG. 5 is an example diagram illustrating registry information defining a configuration of the notification network in FIG. 4 according to embodiments herein.

In this example, registry information 220-2 maintained for server 120-2 indicates that the mobile computer device 125 has been assigned use of communication link 105-1 to transmit and receive messages associated with communication session ABC.

Registry information 220-4 associated with server 120-4 indicates that the communication link 105-2 between client 110-2 and the server 120-4 supports communication session XXY and that the communication link 105-3 between client 110-3 and the server 120-4 supports communication session ADE.

Registry information 220-5 associated with server 120-5 indicates that the communication link 105-4 between client 110-4 and the server 120-5 supports communication session ADE. Registry information 220-5 also indicates that the communication link 105-5 between client 110-5 and the server 120-5 supports communication sessions ADE and XXY.

In this manner, the registry information 220 keeps track of the configuration of the network 190-1. Note that registry information 220 can be stored in any suitable location.

As mentioned, in one embodiment, the servers 120 communicate with each other via broadcasting or multi-casting of notification messages to other servers 120 in the notification network 190-1 regardless of whether a respective server in the notification network 190-1 has any clients registered to participate in the communication session. Thus, all of the servers can receive a broadcasted message. However, as mentioned above, only certain servers forward the received broadcasted message to a respective client depending on whether the respective client is a member of a respective communication session to which the message is directed.

Thus, via broadcast messaging as discussed herein, the clients are able to communicate with each other. As mentioned, the communication link 105-1 can be persistent enabling receipt of communications from other members that have joined or that eventually join communication session ABC.

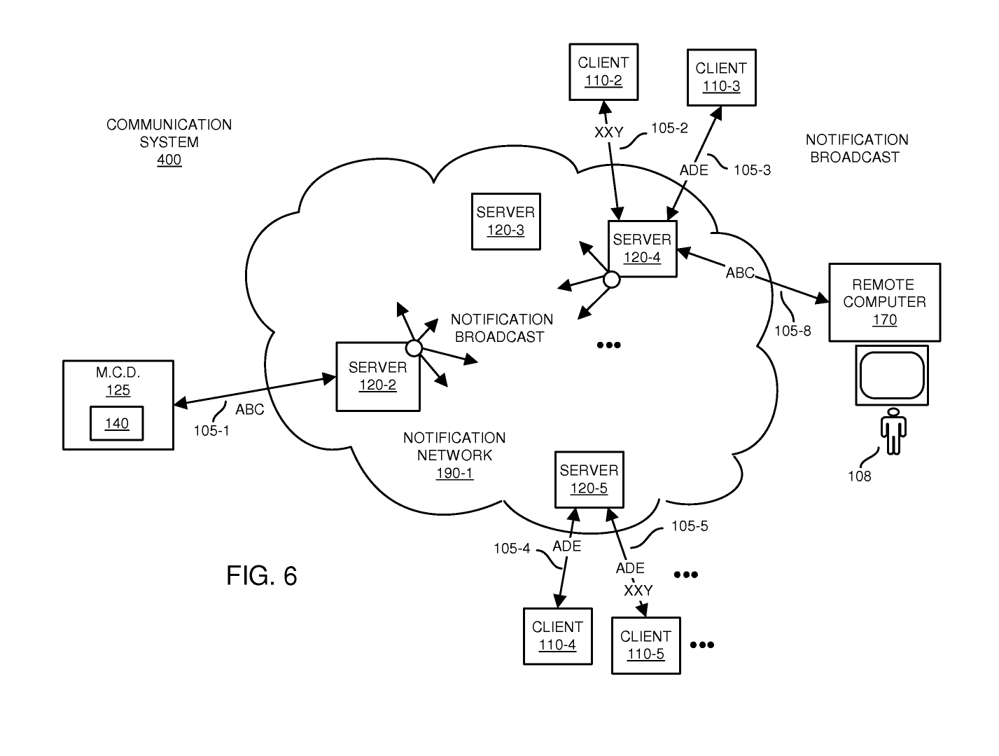

FIG. 6 is an example diagram illustrating how a remote computer can join a communication session in notification network to control a remotely located mobile computer device according to embodiments herein.

Maintaining the communication link 105-1 as a persistently active link enables control of the mobile computer device 125 at any time. For example, assume that the mobile computer device 125 installs and/or executes the agent application 140 in a manner as previously discussed. That is, the agent application 140 is executed even though the mobile computer device 125 may be unpowered or is in a sleep mode.

An access manager or central authority in communication system 600 keeps track of the presence/availability of the communication link 105-1. To communicate with the mobile computer device 125, and to control the mobile computer device 125 from remote computer 170 as discussed herein, the remote resource 170 can be configured to send a message to the access manager in notification network 190-1 requesting to establish a connection with the mobile computer device 125.

In such an instance, prior to providing information enabling the remote computer 170 to communicate with the mobile computer device 125, the access manager may request that the remote resource 170 and/or user 108 provide appropriate credentials to prove that the requesting party (e.g., user 108) is authorized to join communication session ABC and communicate with the agent application 140 in the mobile computer device 125.

If proper access credentials are provided, as shown, the access manager initiates creation of the communication link 105-8 enabling the remote computer 170 to communicate with the mobile computer device 125 over communication session ABC. In other words, because the remote computer 170 becomes a member of session ABC, the remote computer 170 is now able to communicate with the agent application 140 on the mobile computer device 125.

Note that the agent application 140 may require that the remote computer 170 provide further authorization information such as a proper password prior to allowing the user at remote computer 170 to control the mobile computer device 125.

Thus, because the communication link 105-1 is persistent, the remote resource 170 (or any other resource) can connect and communicate with the agent application 140 in mobile computer device 125 for control purposes at any time.

In a manner as previously discussed, subsequent to joining the communication session ABC via establishing a communication link 105-8 between the remote computer 170 and server 120-4, in a manner as previously discussed, the remote computer 170 transmits control input 165-1 over communication session ABC to the agent application 140 on the mobile computer device 125. As previously discussed, in a reverse direction over communication session ABC, the mobile computer device 125 transmits display information 166 to the remote computer 170.

To remotely control the mobile computer device 125, the remote computer 170 sends a message to the mobile computer device 125 over communication session ABC. The operating system 110 detects presence of the message on the socket and provides notification to the agent application 140 of the message. At a time prior to receiving the notification, the agent application may not perform any operations or instructions (e.g., the agent application 140 uses substantially little or no processor clock cycles to execute) until after being notified of the message from the remote computer 170. That is, after being notified of a received message, the agent application 140 may require one or more processor clock cycles to process the received message(s).

Thus, the agent application 140 can be configured to receive notification of an attempt by the remote computer 170 to contact the agent application 140 while it is in a standby mode. In response to receiving the notification, the agent application 140 switches its operation from a standby mode in which the agent application 140 uses substantially little or no processor clock cycles to an active mode in which the agent application 140 receives and process messages from the remote computer 170 received over communication link 105-1 and corresponding socket.

Thus, the mobile computer device 125 as discussed herein can establish a socket on which to receive communications directed to the agent application 140. In one embodiment, the agent application 140, while in a standby mode, receives notification (e.g., based on a message from the user 108 at the remote computer attempting to remotely control the mobile computer device 125) from the operating system 110 that a message was received on the socket assigned for use to receive communications on communication session ABC. In response to receiving the notification, the agent application 140 goes into an active mode and initiates execution of the emulator resource 180 to translate a respective one or more messages (e.g., control input 165-1) received from the remote computer 170.

As previously discussed, it is possible that the mobile computer device 125 is powered down at a time of receiving the message from the remote computer 170. In such an instance, the message received from the remote computer 170 is still received on the socket. In response to receiving the message, as mentioned above, the operating system 110 provides notification to the agent application 140 that a message has been received on communication session ABC. Even though the mobile computer device 125 may be powered down, the agent application 140 wakes up and utilizes the emulator resource 180 to translate the received one or more messages into function calls to the operating system 110. Thus, in accordance with one embodiment, execution of the emulator resource 180 while mobile computer device 125 is un-powered enables control of the mobile computer device 125.

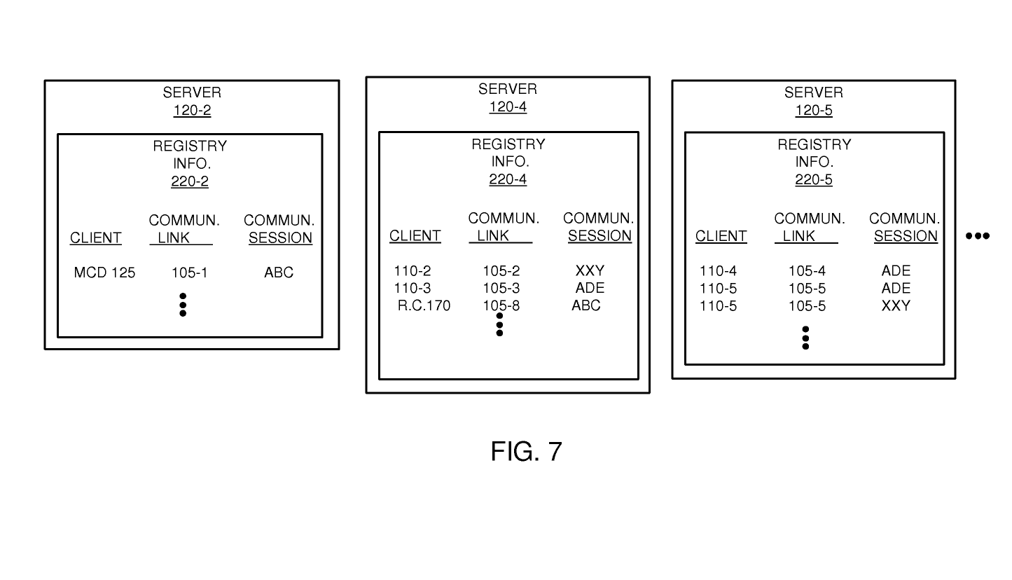

FIG. 7 is an example diagram illustrating registry information defining a configuration of the notification network in FIG. 6 subsequent to the remote computer joining communication session ABC according to embodiments herein.

As shown, registry information 220-4 has been updated to indicate that remote computer 170 is a client coupled to server 120-4 and that communication link 105-8 supports transmission of messages for communication session ABC.

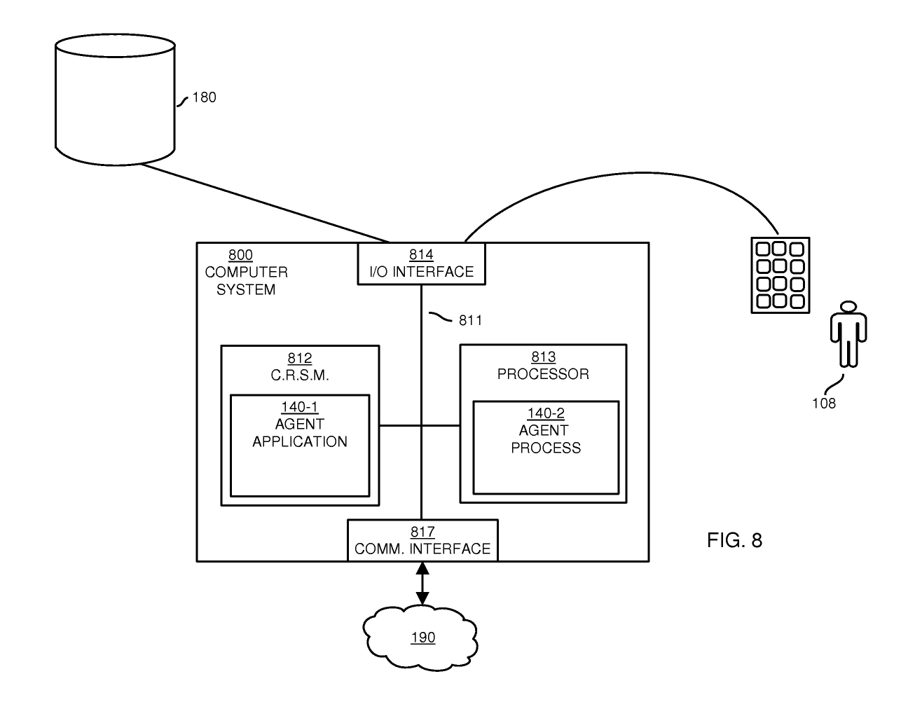

FIG. 8 is an example block diagram of a computer hardware system for executing operations according to embodiments herein. Any of the functionality and/or resources as discussed herein (e.g., agent application 140, mobile computer device 125, remote computer 170, servers, etc.) can be executed with computer system 800 or the like to perform functionality as discussed herein.

Computer system 800 (e.g., computer hardware, software, etc.) can be or include one or more computerized devices such as a mobile computer device, personal computer, workstation, portable computing device, mobile device, handheld device, console, network terminal, processing device, network device, etc.

Note that the following discussion provides a basic embodiment indicating how to execute functionality according to embodiments herein using a computer system. However, it should be noted that the actual configuration for carrying out the operations as described herein can vary depending on a respective application.

As shown, computer system 800 of the present example includes an interconnect 811 that couples computer readable hardware storage media 812 (i.e., a non-transitory type of computer readable storage media) in which digital information can be stored and/or retrieved, a processor device 813, I/O interface 814, a communications interface 817, etc.

I/O interface 814 provides connectivity to different resources such as a repository, display screen, keyboard, computer mouse, etc.

Computer readable hardware storage medium 812 can be any suitable device such as memory, optical storage, hard drive, floppy disk, etc. In one embodiment, the computer readable storage medium 812 is a non-transitory computer readable storage media (i.e., any hardware storage media ort medium) to store instructions and/or data.

Communications interface 817 enables the computer system 800 and processor device 813 to communicate over a network 190 to retrieve information from remote sources and communicate with other computers. I/O interface 814 enables processor device 813 to retrieve respective information from a repository.

As shown, computer readable storage media 812 can be encoded with agent application 140-1 (e.g., software, firmware, etc.) executed by processor 813.

During operation of one embodiment, processor device 813 (e.g., one or more computer devices) accesses computer readable storage media 812 via the use of interconnect 811 in order to launch, run, execute, interpret or otherwise perform the instructions of agent application 140-1 stored on computer readable storage medium 812. Agent application 140-1 can include appropriate instructions, logic, etc., to carry out any or all functionality associated with the resources (e.g., clients, servers, notification network, network administrator, etc.) in a computer network environment as discussed herein.

Execution of the agent application 140-1 produces processing functionality such as agent process 140-2 in processor device 813. In other words, the agent process 140-2 associated with processor device 813 represents one or more aspects of executing agent application 140-1 within or upon the processor device 813 in the computer system 800.

Those skilled in the art will understand that the computer system 800 can include other processes and/or software and hardware components, such as an operating system that controls allocation and use of hardware resources to execute agent application 140-1.

In accordance with different embodiments, note again that computer system 800 may be any of various types of devices, including, but not limited to, a mobile computer device, personal computer system, desktop computer, laptop, notebook, netbook computer, mainframe computer system, handheld computer, workstation, network computer, application server, storage device, a consumer electronics device such as a camera, camcorder, set top box, mobile device, portable handheld device, video game console, handheld video game device, a peripheral device such as a switch, modem, router, or in general any type of computing or electronic device.

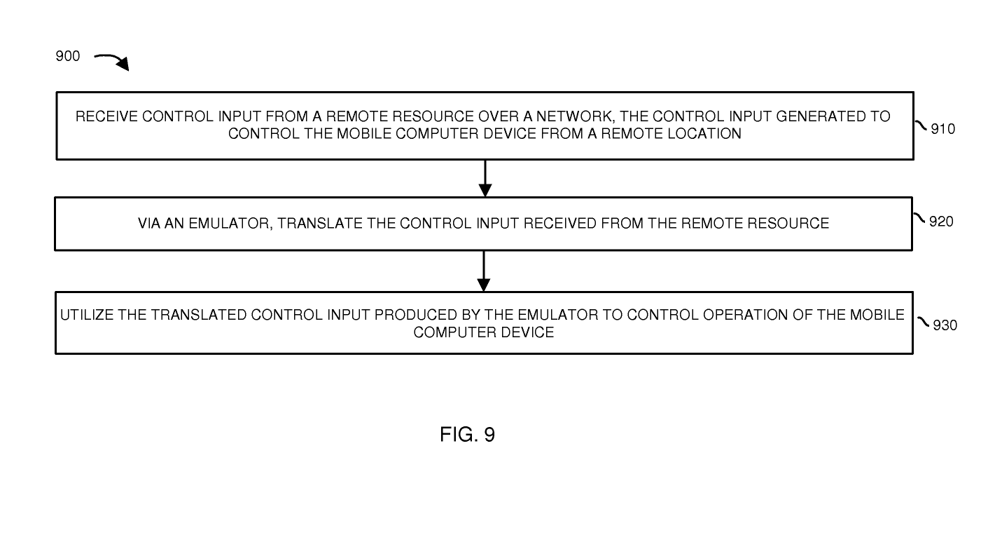

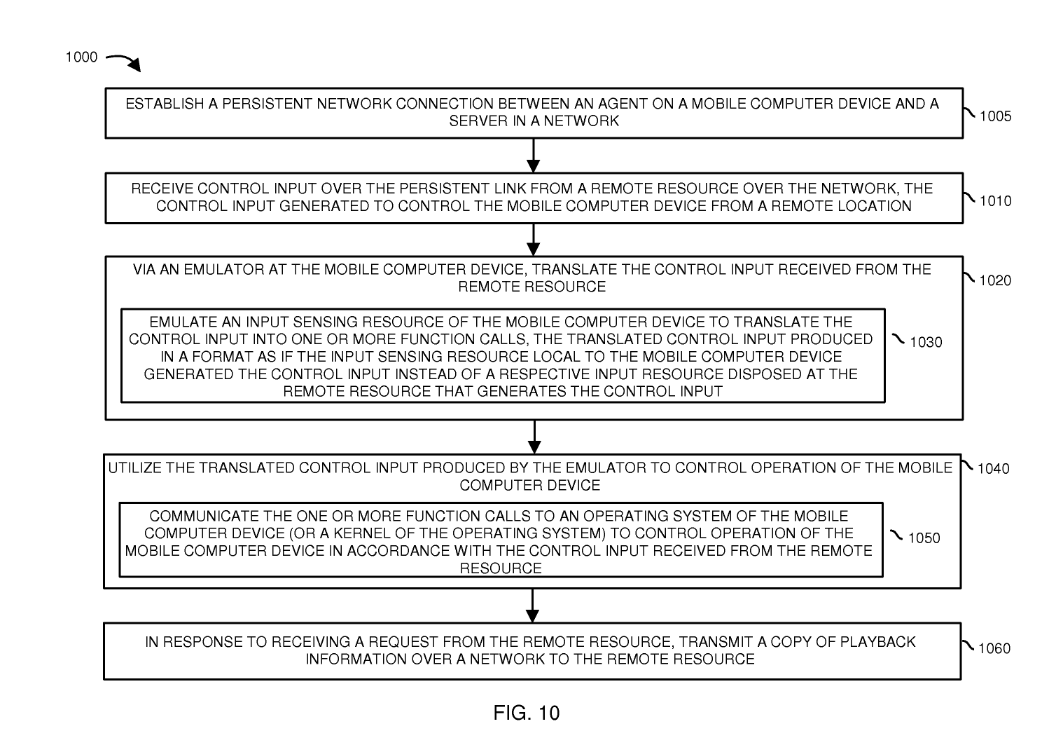

Functionality supported by resources in network environment and resources therein will now be discussed via flowcharts in FIGS. 9 and 10. Note that there will be some overlap with respect to concepts discussed above for FIGS. 1 through 8. Also, note that the steps in the below flowcharts need not always be executed in the order shown. That is, the steps can be executed in any suitable order.

FIG. 9 is a flowchart illustrating an example method facilitating remote control of a mobile computer device according to embodiments herein.

In step 910, the agent application 140 in the mobile computer device 125 receives control input 165-1 from a remote resource such as a remote computer 170 over network 190. In one embodiment as mentioned, the remote computer 170 or other suitable resource the generates the control input 165-1 to control the mobile computer device 125 from the remote location

In step 920, the emulator resource 180 associated with the agent application 140 translates the control input 165-1 received from the remote computer 170.

In step 930, the agent application 180 utilizes the translated control input 165-2 produced by the emulator resource 180 to control operation of the mobile computer device 125.

FIG. 10 is a flowchart illustrating an example method facilitating control of a mobile computer device according to embodiments herein.

In step 1005, the mobile computer device 125 executes the agent application 140 and establishes a persistent open network connection between the agent application 140 and the server 120-2 in network 190-1.

In sub-step 1010, the mobile computer device 125 receives control input 165-1 over the persistent open network connection from the remote computer 170 over the network 190. The user 108 at the remote computer 170 generates the control input 165-1 to control the mobile computer device 125 from a remote location.

In step 1020, the emulator resource 180 (disposed at a location such as the mobile computer device 125, remote computer, computer resource in network 190-1, etc.) translates the control input 165-1 received from the remote computer 170.

In sub-step 1030, the emulator resource 180 of the mobile computer device 125 emulates an input sensing resource to translate the control input 165-1 into control input 165-2 such as one or more function calls 350. In one embodiment, the translated control input (i.e., control input 165-2) is produced in a format as if an input sensing resource local to the mobile computer device 125 generated the control input 165-2 instead of a respective input resource disposed at the remote computer 170 that actually generates the control input 165-1.

In step 1040, the mobile computer device 125 utilizes the translated control input 165-2 produced by the emulator resource 180 to control operation of the mobile computer device 125. Control by the user 108 at the remote computer can include functions such as turning the mobile computer device 125 ON and OFF, executing applications on the mobile computer device 125, etc.

In sub-step 1050, the mobile computer device 125 initiate execution of the one or more function 350 calls by the operating system 110 of the mobile computer device 125 to control operation of the mobile computer device 125 in accordance with the control input 165-1 received from the remote computer 170.

In step 1010, in response to receiving a request for display information from the remote computer, the agent application 140 in the mobile computer device 125 initiates transmission of a copy of playback information intended for playback at the mobile computer device 125 over network 190 to the remote computer 170.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

We claim:

1. A method comprising:
at an agent application executing on a mobile computer device, receiving control input from a remote resource over a network, the control input generated to control the mobile computer device from a remote location over a network;
via an emulator in the mobile computer device, translating the control input received from the remote resource; and
utilizing the translated control input produced by the emulator to control operation of the mobile computer device.

2. The method as in claim 1, wherein translating the control input includes:
emulating an input sensing resource of the mobile computer device to translate the control input into at least one function call.

3. The method as in claim 2, wherein utilizing the translated control input produced by the emulator to control operation of the mobile computer device includes:
initiating execution of the at least one function call by an operating system of the mobile computer device to control operation of the mobile computer device in accordance with the control input received from the remote resource.

4. The method as in claim 3, wherein initiating execution of the at least one function call includes:
submitting the at least one function call directly to a kernel of the operating system for execution.

5. The method as in claim 1 further comprising:
establishing a persistent network connection between the agent application in the mobile computer device and a server in the network;
receiving the control input from the remote resource over the persistent network connection; and
inputting the control input to the emulator.

6. The method as in claim 1, wherein translating the control input received from the remote resource includes:
emulating an input sensing resource compatible with the mobile computer device to produce the translated control input, the translated control input produced in a format as if a local input sensing resource of the mobile computer device generated the control input instead of a respective input resource disposed at the remote resource that generates the control input.

7. The method as in claim 1 further comprising:
executing the emulator on the mobile computer device during a condition in which the mobile computer device is in a powered down state, execution of the emulator during the powered down state enabling control of the mobile computer device via the control input received from the remote resource over a network connection.

8. The method as in claim 1 further comprising:
spoofing an operating system of the mobile computer device that the operating system is driving a locally disposed auxiliary display device in addition to driving a main display screen of the mobile computer device;
storing, in a buffer of the mobile computer device, image information including a copy of images produced for display on the main display screen of the mobile computer device; and
via the agent application executing in the mobile computer device, initiating transmission of the image information over a network to the remote resource.

9. The method as in claim 1 further comprising:
setting parameters to control local generation of playback information in the mobile computer device, the parameters set in accordance with a display screen at the remote resource controlling the mobile computer device;
in accordance with the parameters, storing the playback information in a buffer of the mobile computer device, the playback information including a copy of images produced for display on a main display screen of the mobile computer device; and
initiating transmission of the playback information in the buffer over a network to the remote resource.

10. The method as in claim 1 further comprising:
in response to receiving a request from the remote resource, transmitting a copy of display information for local display on the mobile computer device over a network to the remote resource.

11. The method as in claim 1 further comprising:
operating the agent application in a standby mode;
receiving notification of an attempt by the remote resource to contact the agent application and control the mobile computer device; and
in response to receiving the notification, switching operation of the agent application to a non-sleep mode to receive the control input used to control the mobile computer device.

12. The method as in claim 1 further comprising:
initiating execution of the agent application on the mobile computer device during a reboot of the mobile computer device, the agent application including the emulator which is persistently executed as a background process on the mobile computer device to receive the control input.

13. The method as in claim 1 further comprising:
establishing a socket on which to receive communications directed to the agent application;
receiving a message on the socket directed to the agent application;
at the agent application, while in a standby mode, receiving notification from the operating system that the message was received on the socket; and
in response to receiving the notification, initiating execution of the emulator to translate the control input.

14. The method as in claim 1 further comprising:
emulating pressing of a physical button the mobile computer device based on the control input received from the remote computer.

15. A computer hardware system comprising:
at least one processor device;
a hardware repository that stores instructions associated with an application executed by the at least one processor; and
an interconnect coupling the processor and the hardware repository, the interconnect causing the at least one process device to execute the application and perform operations of:
at an agent application executing on a mobile computer device, receiving control input from a remote resource over a network, the control input generated to control the mobile computer device from a remote location over a network;
via an emulator in the mobile computer device, translating the control input received from the remote resource; and
utilizing the translated control input produced by the emulator to control operation of the mobile computer device.

16. The computer hardware system as in claim 15, wherein translating the control input includes:
emulating an input sensing resource of the mobile computer device to translate the control input into at least one function call.

17. The computer hardware system as in claim 15, wherein utilizing the translated control input produced by the emulator to control operation of the mobile computer device includes:
initiating execution of the at least one function call by an operating system of the mobile computer device to control operation of the mobile computer device in accordance with the control input received from the remote resource.

16. The computer hardware system as in claim 15, wherein initiating execution of the at least one function call includes:
submitting the at least one function call directly to a kernel of the operating system for execution.

19. The computer hardware system as in claim 15, wherein the at least one processor device further supports operations of:
establishing a persistent network connection between the agent application in the mobile computer device and a server in the network;
receiving the control input from the remote resource over the persistent network connection; and
inputting the control input to the emulator.

20. The computer hardware system as in claim 15, wherein translating the control input received from the remote resource includes:
emulating an input sensing resource compatible with the mobile computer device to produce the translated control input, the translated control input produced in a format as if a local input sensing resource of the mobile computer device generated the control input instead of a respective input resource disposed at the remote resource that generates the control input.

21. The computer hardware system as in claim 15, wherein the at least one processor device further supports operations of:
executing the emulator on the mobile computer device during a condition in which the mobile computer device is in a powered down state, execution of the emulator during the powered down state enabling control of the mobile computer device via the control input received from the remote resource over a network connection.

22. The computer hardware system as in claim 15, wherein the at least one processor device further supports operations of:
spoofing an operating system of the mobile computer device that the operating system is driving a locally disposed auxiliary display device in addition to driving a main display screen of the mobile computer device;
storing, in a buffer of the mobile computer device, image information including a copy of images produced for display on the main display screen of the mobile computer device; and
via the agent application executing in the mobile computer device, initiating transmission of the image information over a network to the remote resource.

23. The computer hardware system as in claim 15, wherein the at least one processor device further supports operations of:
setting parameters to control local generation of playback information in the mobile computer device, the parameters set in accordance with a display screen at the remote resource controlling the mobile computer device;
in accordance with the parameters, storing the playback information in a buffer of the mobile computer device, the playback information including a copy of images produced for display on a main display screen of the mobile computer device; and
initiating transmission of the playback information in the buffer over a network to the remote resource.

24. The computer hardware system as in claim 15, wherein the at least one processor device further supports operations of:
in response to receiving a request from the remote resource, transmitting a copy of display information for local display on the mobile computer device over a network to the remote resource.

25. The computer hardware system as in claim 15, wherein the at least one processor device further supports operations of:
operating the agent application in a standby mode;
receiving notification of an attempt by the remote resource to contact the agent application and control the mobile computer device; and
in response to receiving the notification, switching operation of the agent application to a non-sleep mode to receive the control input used to control the mobile computer device.

26. The computer hardware system as in claim 15, wherein the at least one processor device further supports operations of:
initiating execution of the agent application on the mobile computer device during a reboot of the mobile computer device, the agent application including the emulator which is persistently executed as a background process on the mobile computer device to receive the control input.

27. The computer hardware system as in claim 15, wherein the at least one processor device further supports operations of:
establishing a socket on which to receive communications directed to the agent application;
receiving a message on the socket directed to the agent application;
at the agent application, while in a standby mode, receiving notification from the operating system that the message was received on the socket; and
in response to receiving the notification, initiating execution of the emulator to translate the control input.

28. A computer-readable hardware storage medium having instructions stored thereon for processing data information, such that the instructions, when carried out by at least one processing device, cause the at least one processing device to perform operations of:
receiving control input from a remote resource over a network, the control input generated to control the mobile computer device from a remote location over a network;
via emulation, translating the control input received from the remote resource; and
utilizing the translated control input produced by the emulator to control operation of the mobile computer device.
